(19) United States
(12) Patent Application Publication
(10) Pub. No.: US 2026/0063199 A1
(43) Pub. Date: Mar. 5, 2026

(54) HEAT MANAGEMENT SYSTEM

(71) Applicant: TOYOTA JIDOSHA KABUSHIKI KAISHA, Toyota-shi (JP)

(72) Inventor: Hiroshi Yamamoto, Toyota-shi (JP)

(73) Assignee: TOYOTA JIDOSHA KABUSHIKI KAISHA, Toyota-shi (JP)

(21) Appl. No.: 19/266,229

(22) Filed: Jul. 11, 2025

(30) Foreign Application Priority Data
Sep. 3, 2024 (JP) 2024-151698

(51) Int. Cl. F16H 57/04; H01M 10/625; H01M 10/66

(52) U.S. Cl. CPC F16H 57/0435; F16H 57/0415; H01M 10/66; H01M 10/625

(57) ABSTRACT

A heat management system includes: an oil circuit where oil circulates; an LT circuit where cooling water circulates; an LT radiator provided in the LT circuit, and an oil cooler that performs heat exchange between the oil and the cooling water. The oil circuit causes the oil to circulate to a secondary battery and a transaxle that reduces a rotation speed of a motor.

### CROSS REFERENCE TO RELATED APPLICATIONS

This nonprovisional application is based on Japanese Patent Application No. 2024-151698 filed on Sep. 3, 2024 with the Japan Patent Office, the entire contents of which are hereby incorporated by reference.

### BACKGROUND

### Field

The present disclosure relates to a heat management system.

### Description of the Background Art

Japanese Patent Laying-Open No. 2024-082099 discloses a configuration in which a circulation circuit causes a lubricating oil composition to circulate to a secondary battery, a reducer of a motor, and a radiator. The temperature of the secondary battery is controlled by the lubricating oil composition.

### SUMMARY

In Japanese Patent Laying-Open No. 2024-082099, the circulation circuit causes the lubricating oil composition to circulate to the secondary battery, the reducer and the radiator, as described above. It is conceivable to use heat generated from the reducer in order to raise the temperature of the secondary battery. In this case, when an amount of the lubricating oil composition circulating in the circulation circuit is large, a period of time required to raise the temperature of the lubricating oil composition using the heat of the reducer becomes longer. Due to this, a period of time required to raise the temperature of the secondary battery (power storage device) becomes longer.

The present disclosure has been made to solve the above-described problem, and an object thereof is to provide a heat management system capable of inhibiting a period of time required to raise the temperature of a power storage device using heat of a reducer from becoming longer.

A heat management system according to an aspect of the present disclosure includes: a first circuit where a lubricating oil composition circulates; a second circuit where a coolant circulates; a radiator provided in the second circuit; and a heat exchanger that performs heat exchange between the lubricating oil composition and the coolant. The first circuit causes the lubricating oil composition to circulate to a power storage device and a reducer that reduces a rotation speed of a motor.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a configuration of a heat management system according to an embodiment.

FIG. 2 is a diagram showing a first communicating pattern of a heat management circuit according to the embodiment.

FIG. 3 is a diagram showing a second communicating pattern of the heat management circuit according to the embodiment.

FIG. 4 is a diagram showing a third communicating pattern of the heat management circuit according to the embodiment.

FIG. 5 is a diagram showing a fourth communicating pattern of the heat management circuit according to the embodiment.

FIG. 6 is a diagram showing a fifth communicating pattern of the heat management circuit according to the embodiment.

FIG. 7 is a diagram showing a sixth communicating pattern of the heat management circuit according to the embodiment.

FIG. 8 is a diagram showing a seventh communicating pattern of the heat management circuit according to the embodiment.

FIG. 9 is a diagram showing an eighth communicating pattern of the heat management circuit according to the embodiment.

### DESCRIPTION OF THE PREFERRED EMBODIMENTS

An embodiment of the present disclosure will be described with reference to the drawings. In the drawings referenced below, the same or corresponding members are denoted by the same reference numerals.

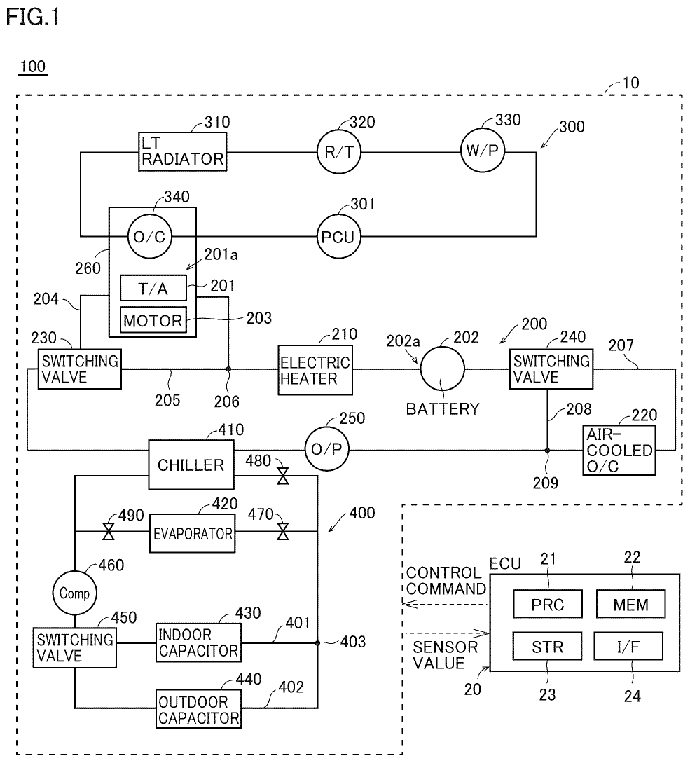

FIG. 1 is a diagram showing a configuration of a heat management system 100. Heat management system 100 is, for example, used for heat management of various devices mounted on a vehicle. Heat management system 100 is not limited to being used in the vehicle.

Heat management system 100 includes a heat management circuit 10 and an electronic control unit (ECU) 20. Heat management circuit 10 includes an oil circuit 200, a low temperature (LT) circuit 300 and a refrigerant circuit 400. Oil circuit 200 and LT circuit 300 are examples of “first circuit” and “second circuit” in the present disclosure, respectively.

Oil circuit 200 is a circuit where oil circulates. The oil is, for example, an automatic transmission fluid (ATF) used in a transmission of an AT vehicle. The viscosity of the oil is kept low from a low temperature range to a high temperature range. For example, the lubricating oil composition disclosed in above-described Japanese Patent Laying-Open No. 2024-082099 may be used as the oil in oil circuit 200. The oil is an example of “lubricating oil composition” in the present disclosure.

LT circuit 300 is a circuit where cooling water circulates. Refrigerant circuit 400 is a circuit where a refrigerant (a gas-phase refrigerant or a liquid-phase refrigerant) circulates. The cooling water is an example of “coolant” in the present disclosure.

Heat management system 100 (heat management circuit 10) includes an electric heater 210, an air-cooled oil cooler 220, a switching valve 230, a switching valve 240, an oil pump 250, and a housing 260, all of which are provided in oil circuit 200. Housing 260 houses a transaxle 201 described below. Switching valve 230 and switching valve 240 are examples of “switching valve for the reducer” and “switching valve for the heat emitter” in the present disclosure, respectively. Electric heater 210 and air-cooled oil cooler 220 are examples of “heater” and “heat emitter” in the present disclosure, respectively.

Electric heater 210 heats the oil circulating in oil circuit 200. Air-cooled oil cooler 220 releases heat of the oil circulating in oil circuit 200. Air-cooled oil cooler 220 is, for example, a device including a pipe through which the oil circulates and a fin attached to the pipe.

Heat management system 100 (heat management circuit 10) includes an LT radiator 310, a reservoir tank 320, a water pump 330, and an oil cooler 340, all of which are provided in LT circuit 300. LT radiator 310 and oil cooler 340 are examples of “radiator” and “heat exchanger” in the present disclosure, respectively.

Oil cooler 340 performs heat exchange between the oil circulating in oil circuit 200 and the cooling water circulating in LT circuit 300. Specifically, the heat exchange is performed between the cooling water flowing in oil cooler 340 and the oil coming into contact with oil cooler 340. Details will be described below.

LT circuit 300 causes the cooling water to circulate to an electronic component such as a power control unit (PCU) 301. PCU 301 converts DC power supplied from a secondary battery 202 described below into AC power and supplies the AC power to a motor 203. The above-described electronic component may include, for example, an electronic component included in an advanced driver-assistance systems (ADAS) or the like.

Heat management system 100 (heat management circuit 10) includes a chiller 410, an evaporator 420, an indoor capacitor 430, an outdoor capacitor 440, a switching valve 450, a compressor 460, electromagnetic valves 470 and 480, and an evaporative pressure regulator (EPR) 490, all of which are provided in refrigerant circuit 400. Each of electromagnetic valves 470 and 480 has the function of restricting a flow of the refrigerant in accordance with a control command from ECU 20 (FIG. 1), and also has the function of expanding the liquid-phase refrigerant.

ECU 20 controls heat management circuit 10. ECU 20 includes a processor 21, a memory 22, a storage 23, and an interface 24.

Processor 21 is, for example, a central processing unit (CPU) or a micro-processing unit (MPU). Memory 22 is, for example, a random access memory (RAM). Storage 23 is a rewritable non-volatile memory such as a hard disk drive (HDD), a solid state drive (SSD) or a flash memory. Storage 23 stores a system program including an operating system (OS) and a control program including computer readable codes required for control operation. Processor 21 reads the system program and the control program, loads these programs onto memory 22, and executes these programs, thereby implementing various processes. Interface 24 controls communication between ECU 20 and the components of heat management circuit 10.

ECU 20 generates a control command based on sensor values obtained from various sensors included in heat management circuit 10, a user operation received by a not-shown human machine interface (HMI), and the like, and outputs the generated control command to heat management circuit 10. ECU 20 may be divided into a plurality of ECUs depending on the function. Although FIG. 1 shows the example in which ECU 20 includes one processor 21, ECU 20 may include a plurality of processors. The same applies as well to memory 22 and storage 23.

Various sensors described above may include, for example, a temperature sensor (not shown) that detects the temperature of secondary battery 202 (battery), and the like. ECU 20 may also control electric heater 210, switching valves 230, 240 and 450, electromagnetic valves 470 and 480, water pump 330, oil pump 250, compressor 460 and the like in accordance with the above-described control command. Secondary battery 202 is an example of “power storage device” in the present disclosure.

“Processor” herein is not limited to a processor in a narrow sense that performs a process in accordance with a stored program scheme, and may include a hardwired circuit such as an application specific integrated circuit (ASIC) or a field-programmable gate array (FPGA). Therefore, the term “processor” can also be interchangeably read as processing circuitry for which processing is predefined by computer readable codes and/or a hardwired circuit.

In a conventional heat management system, an oil circuit causes oil to circulate to a secondary battery, a transaxle and an LT radiator. In this case, when an amount of the oil circulating in the circulation circuit is large, a period of time required to raise the temperature of a lubricating oil composition using heat of the transaxle becomes longer. Due to this, a period of time required to raise the temperature of the secondary battery becomes longer.

In the present embodiment, oil circuit 200 causes the oil to circulate to transaxle 201 and secondary battery 202. That is, oil circuit 200 does not cause the oil to circulate to LT radiator 310 provided in LT circuit 300. Oil circuit 200 is separated from LT circuit 300. Transaxle 201 is an example of “reducer” in the present disclosure.

With such a configuration, an amount of the oil circulating in oil circuit 200 can be made relatively smaller than that when oil circuit 200 and LT circuit 300 are not separated and a common heat medium flows in each of these circuits. As a result, a period of time required to raise the temperature of the oil using the heat generated from transaxle 201 can be reduced. Thus, a period of time required to raise the temperature of secondary battery 202 can be inhibited from becoming longer.

Transaxle 201 includes a reducer that reduces a rotation speed of motor 203. Specifically, transaxle 201 includes a transmission that changes a speed of rotation of motor 203, and a differential gear that distributes driving force to right and left tires. Motor 203 may be built into transaxle 201. When the vehicle having heat management system 100 mounted thereon is an electric vehicle, an eAxle in which transaxle 201, motor 203, and an inverter of PCU 301 are integrated may be mounted on the electric vehicle.

Housing 260 houses transaxle 201 and oil cooler 340. The oil having flowed into housing 260 comes into contact with transaxle 201 to thereby cool transaxle 201, and thereafter, flows out of housing 260. A part of the oil having flowed into housing 260 (also including the oil having cooled transaxle 201) is suctioned up to oil cooler 340 by a not-shown electric oil pump arranged in housing 260. Thus, heat exchange is performed between the cooling water flowing in oil cooler 340 and the oil.

With such a configuration, heat exchange can be easily performed between the oil having cooled transaxle 201 and the cooling water flowing in oil cooler 340.

Oil circuit 200 causes the oil to circulate to motor 203 as well, in addition to transaxle 201 and secondary battery 202. For example, the oil may flow in a rotor shaft (not shown) provided in motor 203, or may flow through a pipe provided in a jacket (not shown) attached to motor 203.

With such a configuration, heat generated in motor 203 can also be used to raise the temperature of secondary battery 202.

In the example shown in FIG. 1, motor 203 is housed in housing 260. The position where motor 203 is arranged is not limited to the above-described example. Motor 203 may be arranged outside housing 260.

Oil circuit 200 includes a path 204 and a path 205. Housing 260 (transaxle 201 and motor 203) is provided in path 204. That is, path 204 is a path where heat exchange is performed between the oil and transaxle 201 (motor 203). Path 204 and path 205 are examples of “reducer arrangement path” and “reducer bypass path” in the present disclosure, respectively.

When a point at which path 204 and path 205 are connected is defined as a connection point 206, path 204 is a path of switching valve 230-housing 260 (transaxle 201 and motor 203)-connection point 206. Path 205 is a path of switching valve 230-connection point 206. That is, path 205 is a path that bypasses housing 260 (transaxle 201 and motor 203).

Switching valve 230 switches an oil flow path between path 204 and path 205. That is, switching valve 230 performs switching between a state in which the oil flows through only path 204, of path 204 and path 205, and a state in which the oil flows through only path 205, of path 204 and path 205.

Thus, a degree of temperature-raising of the oil using the heat generated from transaxle 201 (and motor 203) can be easily adjusted by switching valve 230.

Oil circuit 200 includes a path 207 and a path 208. Air-cooled oil cooler 220 is provided in path 207. When a point at which path 207 and path 208 are connected is defined as a connection point 209, path 207 is a path of switching valve 240-air-cooled oil cooler 220-connection point 209. Path 208 is a path of switching valve 240-connection point 209. That is, path 208 is a path that bypasses air-cooled oil cooler 220. Path 207 and path 208 are examples of “heat emitter arrangement path” and “heat emitter bypass path” in the present disclosure, respectively.

Switching valve 240 switches the oil flow path between path 207 and path 208. That is, switching valve 240 performs switching between a state in which the oil flows through only path 207, of path 207 and path 208, and a state in which the oil flows through only path 208, of path 207 and path 208.

Thus, a degree of heat release from the oil by air-cooled oil cooler 220 can be easily adjusted by switching valve 240.

Oil circuit 200 has a portion 201a and a portion 202a. Portion 201a is a portion of oil circuit 200 where the oil exchanges heat with transaxle 201. That is, portion 201a may be a portion (space) in housing 260. Portion 202a is a portion of oil circuit 200 where the oil exchanges heat with secondary battery 202. For example, portion 202a may be an oil pipe provided in the jacket (not shown) attached to secondary battery 202. Portion 201a and portion 202a are examples of “first portion” and “second portion” in the present disclosure, respectively.

Electric heater 210 is arranged between portion 201a and portion 202a in oil circuit 200. Specifically, electric heater 210 is arranged on a path between connection point 206 and portion 202a in oil circuit 200.

Thus, the temperature of the oil raised using the heat from transaxle 201 can be further raised by electric heater 210.

Chiller 410 is connected to each of refrigerant circuit 400 and oil circuit 200. Thus, the oil circulating in oil circuit 200 can be cooled by the refrigerant of refrigerant circuit 400 through chiller 410.

Chiller 410 is connected to a flow path between oil pump 250 and switching valve 230 in oil circuit 200. In addition, chiller 410 is connected to a flow path between electromagnetic valve 480 and compressor 460 in refrigerant circuit 400.

Refrigerant circuit 400 includes a path 401 and a path 402. Indoor capacitor 430 is provided in path 401. When a point at which path 401 and path 402 are connected is defined as a connection point 403, path 401 is a path of switching valve 450-indoor capacitor 430-connection point 403. Path 402 is a path of switching valve 450-outdoor capacitor 440-connection point 403.

Switching valve 450 switches a refrigerant flow path between path 401 and path 402. That is, switching valve 450 performs switching between a state in which the refrigerant flows through only path 401, of path 401 and path 402, and a state in which the refrigerant flows through only path 402, of path 401 and path 402.

### <First Communicating Pattern>

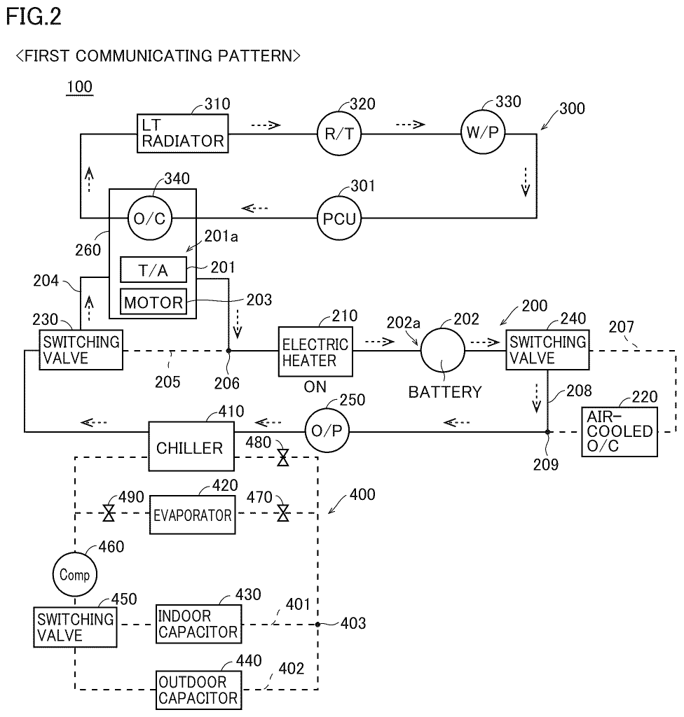

FIG. 2 is a diagram showing a first communicating pattern of heat management circuit 10 when a request to raise the temperature of secondary battery 202 (a request for quick temperature-raising) is received. For the sake of simplicity, ECU 20 is not shown in FIG. 2 and the subsequent figures. In addition, a flow of each of the oil, the cooling water and the refrigerant is shown by a dashed arrow in FIG. 2 and the subsequent figures.

As shown in FIG. 2, switching valve 230 causes the oil to flow through path 204. In addition, switching valve 240 causes the oil to flow through path 208. Therefore, the oil in oil circuit 200 circulates in a closed circuit of switching valve 230-housing 260-electric heater 210-secondary battery 202 (portion 202a)-switching valve 240-oil pump 250-chiller 410-switching valve 230. Thus, the temperature of the oil can be raised using the heat generated in transaxle 201 (and motor 203) and the release of the heat of the oil by air-cooled oil cooler 220 can be prevented.

At this time, electric heater 210 is operating. Thus, the temperature of the oil raised using the heat generated in transaxle 201 (and motor 203) can be further raised by electric heater 210. Electric heater 210 may be stopped in accordance with, for example, the temperature of secondary battery 202 and the like.

In LT circuit 300, the cooling water circulates in a closed circuit of water pump 330-PCU 301-oil cooler 340-LT radiator 310-reservoir tank 320-water pump 330. At this time, the cooling water absorbs heat of the outside air through LT radiator 310. The cooling water also absorbs heat of PCU 301 by cooling PCU 301. The cooling water provides the heat obtained from the outside air and PCU 301 to the oil in oil circuit 200 through oil cooler 340. That is, in the circuit shown in FIG. 2, the heat provided from the cooling water in LT circuit 300 can also be used to raise the temperature of secondary battery 202.

In refrigerant circuit 400, the refrigerant is not circulating. For example, circulation of the refrigerant may be stopped by stopping compressor 460. In addition to (instead of) stopping compressor 460, electromagnetic valves 470 and 480 may be controlled to the closed state.

### <Second Communicating Pattern>

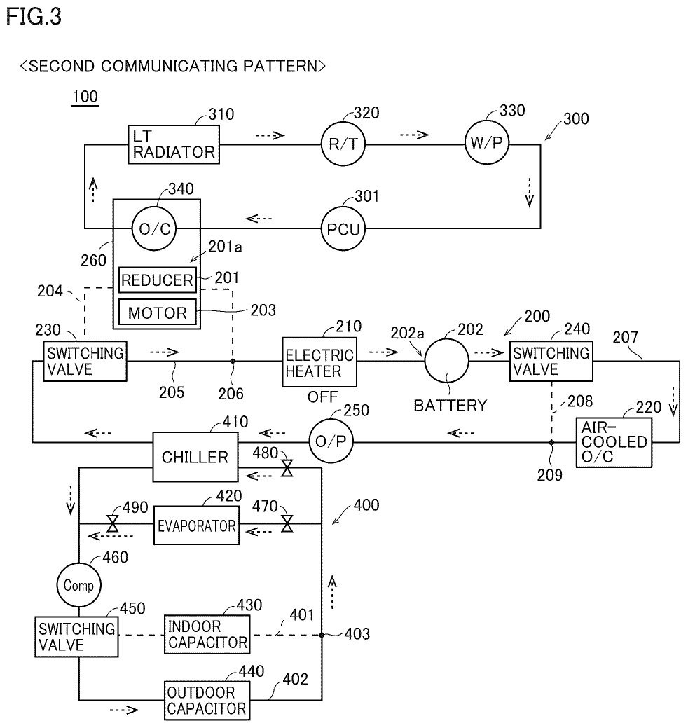

FIG. 3 is a diagram showing a second communicating pattern of heat management circuit 10 when cooling of the electronic component such as PCU 301, cooling of secondary battery 202, and cooling are requested.

As shown in FIG. 3, switching valve 230 causes the oil to flow through path 205. In addition, switching valve 240 causes the oil to flow through path 207. Therefore, the oil in oil circuit 200 circulates in a closed circuit of switching valve 230-electric heater 210-secondary battery 202 (portion 202a)-switching valve 240-air-cooled oil cooler 220-oil pump 250-chiller 410-switching valve 230. At this time, electric heater 210 is not operating. Thus, since the heat of the oil is released by air-cooled oil cooler 220, secondary battery 202 can be cooled.

In LT circuit 300, the cooling water having absorbed the heat of PCU 301 releases the heat to the outside air through LT radiator 310.

In refrigerant circuit 400, path 402 is selected as the refrigerant flow path by switching valve 450. In addition, electromagnetic valves 470 and 480 are controlled to the open state. Therefore, the refrigerant in refrigerant circuit 400 circulates in a first closed circuit of switching valve 450-outdoor capacitor 440-electromagnetic valve 480-chiller 410-compressor 460-switching valve 450 and a second closed circuit of switching valve 450-outdoor capacitor 440-electromagnetic valve 470-evaporator 420-EPR 490-compressor 460-switching valve 450.

The heat of the oil circulating in oil circuit 200 moves to the refrigerant in refrigerant circuit 400 through chiller 410. Outdoor capacitor 440 releases the heat of the refrigerant in refrigerant circuit 400 to the outside air. As a result, the temperature of the refrigerant is decreased, and thus, the refrigerant changes into a liquid phase. The refrigerant having flowed through outdoor capacitor 440 passes through electromagnetic valve 470 and flows into evaporator 420. Thus, the cooling is implemented.

### <Third Communicating Pattern>

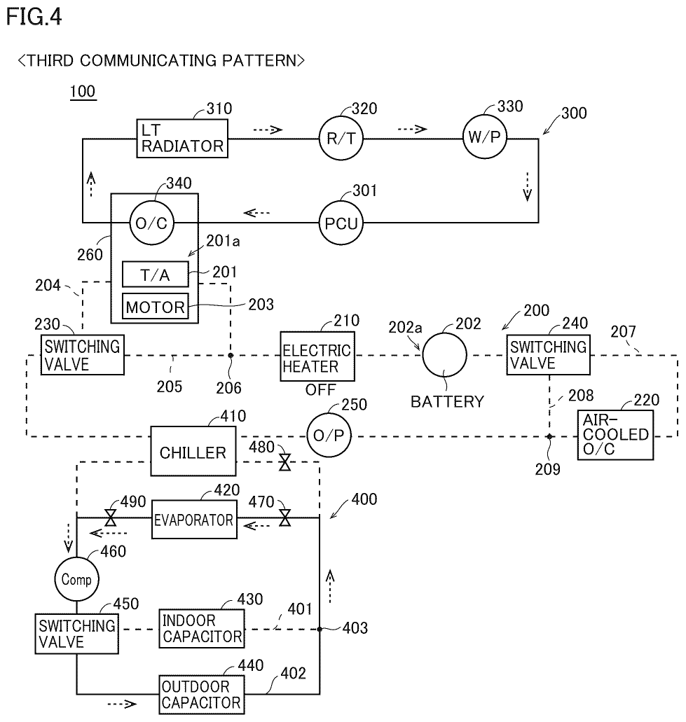

FIG. 4 is a diagram showing a third communicating pattern of heat management circuit 10 when cooling of the electronic component such as PCU 301 and cooling are requested and there is no request about secondary battery 202.

In oil circuit 200, oil pump 250 is not operating, and thus, the oil is not circulating. Electric heater 210 is not operating.

Since LT circuit 300 is in the same state as that in FIG. 3, description will not be repeated.

In refrigerant circuit 400, switching valve 450 causes the refrigerant to flow through path 402. In addition, electromagnetic valve 470 is controlled to the open state and electromagnetic valve 480 is controlled to the closed state. Therefore, the refrigerant in refrigerant circuit 400 circulates in a closed circuit of switching valve 450-outdoor capacitor 440-electromagnetic valve 470-evaporator 420-EPR 490-compressor 460-switching valve 450. Outdoor capacitor 440 releases the heat of the refrigerant in refrigerant circuit 400 to the outside air.

### <Fourth Communicating Pattern>

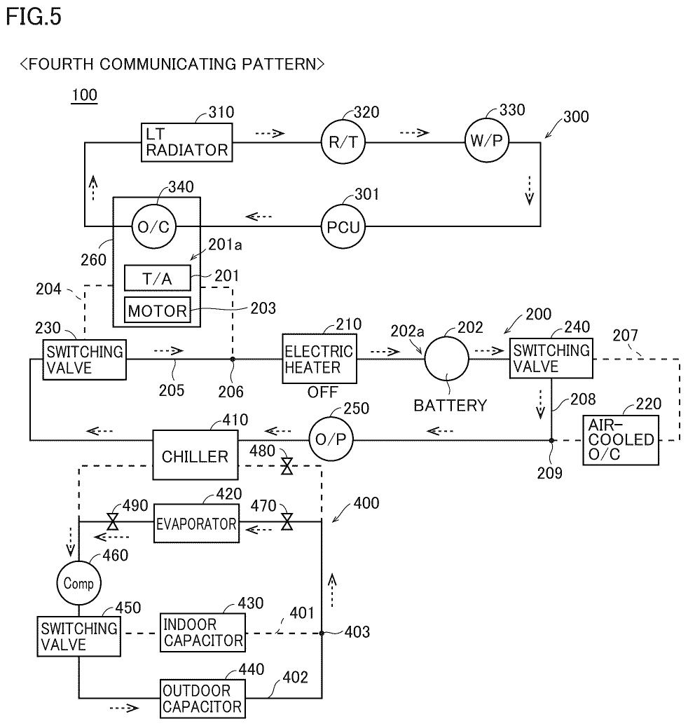

FIG. 5 is a diagram showing a fourth communicating pattern of heat management circuit 10 when cooling of the electronic component such as PCU 301 and cooling are requested and equalization of the temperature of secondary battery 202 is requested.

In oil circuit 200, switching valve 230 causes the oil to flow through path 205. In addition, switching valve 240 causes the oil to flow through path 208. Therefore, the oil in oil circuit 200 circulates in a closed circuit of switching valve 230-electric heater 210-secondary battery 202 (portion 202a)-switching valve 240-oil pump 250-chiller 410-switching valve 230. Electric heater 210 is not operating.

Since LT circuit 300 is in the same state as that in each of FIGS. 3 and 4, description will not be repeated.

Since refrigerant circuit 400 is in the same state as that in FIG. 4, description will not be repeated.

Therefore, the oil in oil circuit 200 is not subject to heat exchange in any of oil cooler 340, chiller 410 and air-cooled oil cooler 220.

### <Fifth Communicating Pattern>

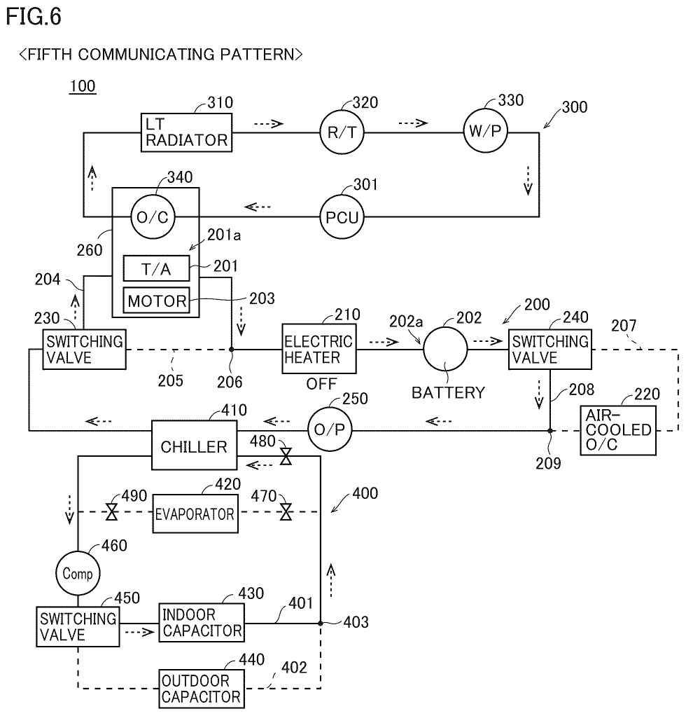

FIG. 6 is a diagram showing a fifth communicating pattern of heat management circuit 10 when heating using the heat of the outside air (heat pump heating) is requested.

Switching valve 230 causes the oil to flow through path 204. In addition, switching valve 240 causes the oil to flow through path 208. Therefore, the oil in oil circuit 200 circulates in a closed circuit of switching valve 230-housing 260-electric heater 210-secondary battery 202 (portion 202a)-switching valve 240-oil pump 250-chiller 410-switching valve 230. At this time, electric heater 210 is not operating.

Since LT circuit 300 is in the same state as that of LT circuit 300 in FIG. 2, description will not be repeated.

In refrigerant circuit 400, switching valve 450 causes the refrigerant to flow through path 401. In addition, electromagnetic valve 470 is controlled to the closed state and electromagnetic valve 480 is controlled to the open state. Therefore, the refrigerant in refrigerant circuit 400 circulates in a closed circuit of switching valve 450-indoor capacitor 430-electromagnetic valve 480-chiller 410-compressor 460-switching valve 450.

Thus, the refrigerant in refrigerant circuit 400 receives the heat from the oil in oil circuit 200 through chiller 410. The refrigerant having received the heat through chiller 410 passes through compressor 460 to thereby change into a high-temperature and high-pressure gas, and thereafter, flows into indoor capacitor 430. Heat of the above-described gas is released to the inside (e.g. to a vehicle compartment) by indoor capacitor 430 and the heat pump heating is thus implemented.

### <Sixth Communicating Pattern>

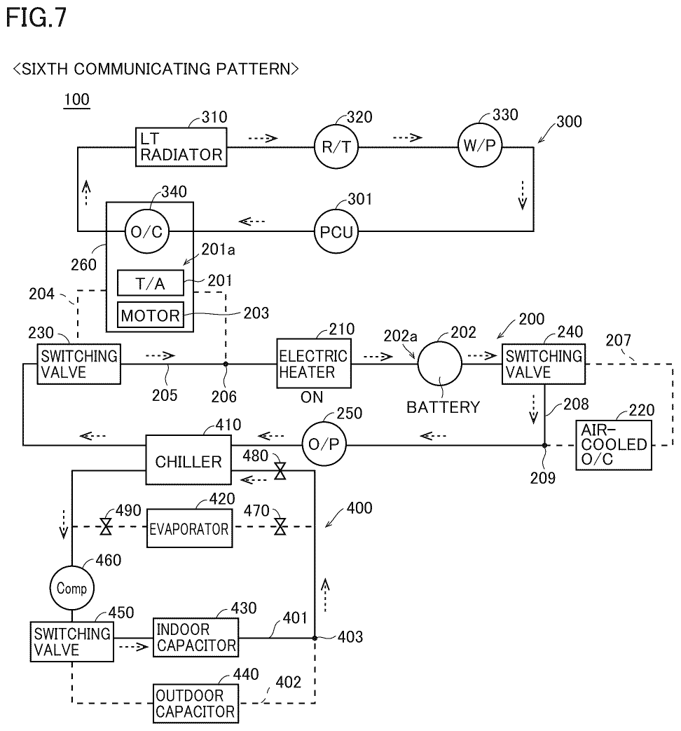

FIG. 7 is a diagram showing a sixth communicating pattern of heat management circuit 10 when heating using electric heater 210 (HVH heating) is requested.

Switching valve 230 causes the oil to flow through path 205. In addition, switching valve 240 causes the oil to flow through path 208. Therefore, the oil in oil circuit 200 circulates in a closed circuit of switching valve 230-electric heater 210-secondary battery 202 (portion 202a)-switching valve 240-oil pump 250-chiller 410-switching valve 230. At this time, electric heater 210 is operating.

In LT circuit 300, the cooling water having absorbed the heat of PCU 301 releases the heat to the outside air through LT radiator 310, similarly to FIG. 3 and the like.

Since refrigerant circuit 400 is the same as that in FIG. 6, description will not be repeated.

### <Seventh Communicating Pattern>

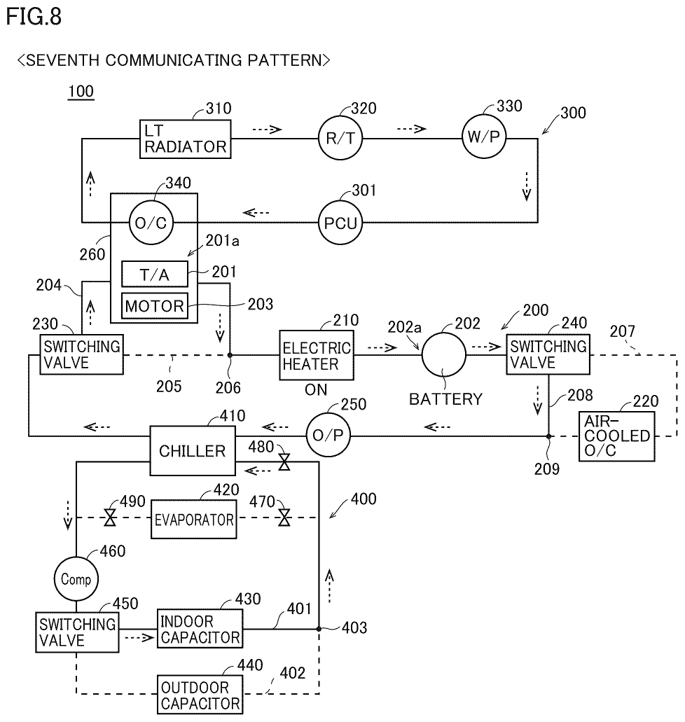

FIG. 8 is a diagram showing a seventh communicating pattern of heat management circuit 10 when quick heating using both the heat pump heating and the HVH heating is requested.

Oil circuit 200 is different from that in FIG. 6 only in that electric heater 210 is operating. Each of LT circuit 300 and refrigerant circuit 400 is in the same state as that in FIG. 6. Thus, the quick heating using the heat of the outside air absorbed by LT radiator 310 and the heat of electric heater 210 is possible.

### <Eighth Communicating Pattern>

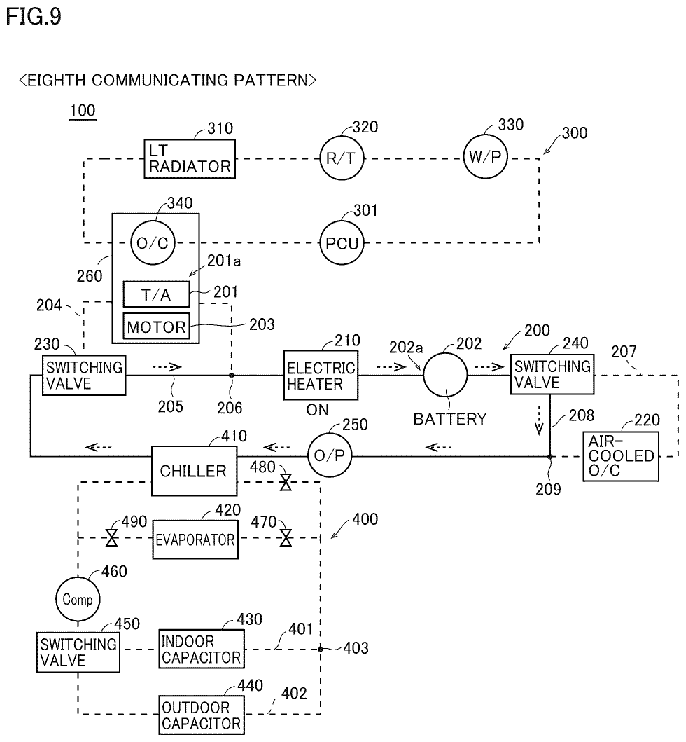

FIG. 9 is a diagram showing an eighth communicating pattern of heat management circuit 10 when a request to raise the temperature of secondary battery 202 (a request for normal temperature-raising) is received, for example. The normal temperature-raising refers to temperature-raising that is lower in temperature raising speed than the quick temperature-raising in FIG. 2.

Oil circuit 200 is in the same state as that of oil circuit 200 in FIG. 7. In LT circuit 300, the cooling water is not circulating. In refrigerant circuit 400, the refrigerant is not circulating. In the example shown in FIG. 9, the temperature of secondary battery 202 is raised using only the heat of electric heater 210.

As described above, in the present embodiment, heat management system 100 includes oil circuit 200 where the oil circulates, and LT circuit 300 where the cooling water circulates, LT circuit 300 being provided with LT radiator 310. Oil circuit 200 causes the oil to circulate to secondary battery 202 and transaxle 201. Therefore, the oil does not circulate through LT radiator 310, which leads to reduction in size of the circuit where the oil circulates. As a result, an increase in amount of the circulating oil can be inhibited. Thus, the temperature of the oil can be easily raised using the heat generated from transaxle 201. As a result, the period of time required to raise the temperature of secondary battery 202 using the heat of transaxle 201 can be inhibited from becoming longer.

### Modifications

Although the example in which heat exchange between the cooling water in oil cooler 340 and the oil in oil circuit 200 is performed in housing 260 that houses transaxle 201 has been described in the embodiment above, the present disclosure is not limited thereto. For example, heat exchange between the cooling water in oil cooler 340 and the oil in oil circuit 200 may be performed in a housing arranged between transaxle 201 and secondary battery 202.

Although the example in which heat exchange between the cooling water and the oil is performed by oil cooler 340 has been described in the embodiment above, the present disclosure is not limited thereto. Heat exchange between the cooling water and the oil may be performed without using oil cooler 340. For example, heat exchange between the cooling water and the oil may be performed by making the flow path through which the cooling water flows and the flow path through which the oil flows adjacent to each other with a heat conducting member or the like interposed therebetween.

Although the example in which oil circuit 200 causes the oil to circulate to motor 203 as well has been described in the embodiment above, the present disclosure is not limited thereto. The oil does not necessarily need to be circulated to motor 203.

Although the example in which transaxle 201 is housed in housing 260 has been described in the embodiment above, the present disclosure is not limited thereto. Only the reducer (transmission) of transaxle 201 may be housed in housing 260.

Although the example in which electric heater 210 is provided in oil circuit 200 has been described in the embodiment above, the present disclosure is not limited thereto. Electric heater 210 does not necessarily need to be provided in oil circuit 200.

Although the embodiment of the present disclosure has been described, it should be understood that the embodiment disclosed herein is illustrative and non-restrictive in every respect. The scope of the present disclosure is defined by the terms of the claims, and is intended to include any modifications within the scope and meaning equivalent to the terms of the claims.

What is claimed is:

1. A heat management system comprising:
a first circuit where a lubricating oil composition circulates;
a second circuit where a coolant circulates;
a radiator provided in the second circuit; and
a heat exchanger that performs heat exchange between the lubricating oil composition and the coolant, wherein
the first circuit causes the lubricating oil composition to circulate to a power storage device and a reducer that reduces a rotation speed of a motor.

2. The heat management system according to claim 1, further comprising:
a chiller; and
a refrigerant circuit where a refrigerant flows, wherein
the chiller is connected to each of the refrigerant circuit and the first circuit.

3. The heat management system according to claim 1, further comprising
a switching valve for the reducer provided in the first circuit, wherein
the first circuit includes:
a reducer arrangement path where the reducer is provided; and
a reducer bypass path that bypasses the reducer, and
the switching valve for the reducer switches a flow path of the lubricating oil composition between the reducer arrangement path and the reducer bypass path.

4. The heat management system according to claim 1, further comprising:
a heat emitter provided in the first circuit to release heat of the lubricating oil composition; and
a switching valve for the heat emitter provided in the first circuit, wherein
the first circuit includes:
a heat emitter arrangement path where the heat emitter is provided; and
a heat emitter bypass path that bypasses the heat emitter, and
the switching valve for the heat emitter switches a flow path of the lubricating oil composition between the heat emitter arrangement path and the heat emitter bypass path.

5. The heat management system according to claim 1, wherein
the heat exchanger includes an oil cooler provided in the second circuit.

6. The heat management system according to claim 5, further comprising
a housing provided in the first circuit, wherein
the housing houses the reducer and the oil cooler.

7. The heat management system according to claim 1, further comprising
a heater provided in the first circuit, wherein
the heater is arranged between a first portion and a second portion, the first portion being a portion of the first circuit where the lubricating oil composition exchanges heat with the reducer, the second portion being a portion of the first circuit where the lubricating oil composition exchanges heat with the power storage device.

8. The heat management system according to claim 1, wherein
the first circuit causes the lubricating oil composition to circulate to the motor.
